(19) United States
(12) Patent Application Publication
(10) Pub. No.: US 2014/0370922 A1
(43) Pub. Date: Dec. 18, 2014

(54) METHOD AND APPARATUS OF PAGING

(71) Applicant: Christopher RICHARDS, Ottawa (CA)

(72) Inventor: Christopher RICHARDS, Ottawa (CA)

(21) Appl. No.: 13/916,920

(22) Filed: Jun. 13, 2013

(51) Int. Cl. H04W 68/02

(52) U.S. Cl. CPC H04W 68/02
USPC 455/458

(57) ABSTRACT

Systems and methods for optimizing paging are disclosed. In one embodiment, a Data Structure with at least one entry mapping at least one identifier representing a candidate wireless device node to at least one identifier representing a candidate paging base station node whereat the candidate wireless device node has some likelihood of being successfully paged by the candidate base station. At least one related paging communication is optimized by using the Data Structure.

### FIELD OF THE DISCLOSURE

The present invention relates to paging over air interfaces and, more particularly, to a method and apparatus of paging suitable for use in long term evolution (LTE) and other applications.

### BACKGROUND

The following abbreviations are used in the present disclosure:
3GPP Third Generation Partnership Project
AP Access Point
DL Down Link (from network towards the UE)
ECGI Evolved Cell Global Identifier
eNB enhanced Node-B
GUTI Globally Unique Temporary Identifier
IMSI International Mobile Subscriber Identity
LTE Long Term Evolution
MME Mobility Management Entity
MTC Machine-Type-Communication
M-TMSI MME-Temporary Mobile Subscriber Identity
PDN-GW Packet Data Network Gateway
PGW PDN Gateway
RAN Radio Access Network
RRC Radio Resource Control
RRM Radio Resource Management (used inter-changeably with RRC in this document)
S2a Signaling procedures for WiFi Integration in 3GPP networks
SGW Signaling Gateway
TA Tracking Area
UE User Equipment
WiFi IEEE 802.11 wireless
WLAN Wireless LAN (a.k.a. WiFi)
HSS Home Subscriber Server

Air interface paging resources are limited such as in for example in the existing paging process described in the following two 3GPPP standards as they existed on the date prior to the filing of this application (hereinafter “3GPP solution”), that are incorporated herein by reference: 3GPP TS 36.331, Evolved Universal Terrestrial Radio Access (E-UTRA), Radio Resource Control (RRC), Protocol specification; and 3GPP TS 23.401, General Packet Radio Service (GPRS) enhancements for Evolved Universal Terrestrial Radio Access Network (E-UTRAN) access.

The 3GPP solution balances the number of eNBs in each TA with the geographical size of the TA. The fewer eNBs that are in a TA may mean fewer eNBs have to broadcast paging requests for a given UE. It also may imply a smaller geographical area of the TA, which may mean that UEs that cross TA boundaries must perform location updates with the network—increasing network load and reducing the UEs battery life. Larger TAs may be better for UE battery life and reduce network signaling associated with UE location updates, but may increase the wasted air interface resources due to paging. This is compounded by the introduction of small cells, wherein more eNBs are in a given TA.

When a UE enters idle mode, the data bearer contexts for that UE are removed from eNB and Serving Gateway (SGW). The paging procedure is initiated by the Serving Gateway (SGW) when it receives data for a UE from the PDN (Packet Data Network) Gateway (PGW) and does not have any bearers setup for that UE. For example, the PGW may receive an email notification, or IMS message or notification of an incoming SIP voice call from the operator's servers or from an external server. The notification or message will be in the format of one or more IP packets, where the destination IP address is the IP address last assigned to the UE. The IP packet(s) will be buffered in the SGW memory while the UE context is attempted to be established. The SGW will request the MME to “find” the UE so that the UE can re-establish a network connection allowing the SGW to route the received and buffered data packets. The S1-AP Paging Request is sent from the MME to all eNBs in the TA where the UE is registered. Each eNB schedules and allocates air interface resources that include the identifier of each UE being paged. All UEs monitor the paging resources and will initiate a connection to the network if the UE finds its own identifier in the list of identities being paged.

The 3GPP LTE Evolved Packet Core (EPC) sends paging requests for UEs when the UE is in an idle state and it's location is only known to a Tracking Area (TA) granularity by the network. The paging requests are sent from the EPC to all eNBs in a Tracking Area (TA). Each eNB must schedule and allocate part of the air interface resources in order to broadcast the paging request for each UE. The air interface paging resources are limited and shared with resources used to transfer data to UEs. The more paging requests that are received, the more of the air interface resources are used for paging reducing the available resources for data transmission. The UE will only ever receive the paging request from one of the eNBs. So that the paging broadcast from all the other eNBs in the TA are ultimately wasted. The waste will be magnified by the following changes in the network and devices:
1. Given the reduction in cell size (due to improving the capacity of the Radio Access Network (RAN)) and the widespread deployment of indoor and outdoor small cells, the number of eNBs within a TA will increase significantly.
2. Introduction of many MTC type devices (e.g. smart electricity/water meters) that are non-mobile and transfer small amounts of data infrequently (being in an idle state most of the time)
3. The RAN is not static. New eNBs are added frequently. In building deployments of venue type nodes.
Changing TA boundaries in order to mitigate the paging resource problem is a complicated and costly task that is not undertaken lightly.

It would be advantageous to provide an apparatus and method of paging that may be able to reduce paging overhead while limiting re-engineering the tracking areas in a radio access network.

It would also be advantageous to provide an apparatus and method of paging that may have limited impact on any external, standardized interfaces.

### SUMMARY

Methods and apparatus of paging are disclosed. Note, however, that while the methods and apparatus disclosed herein are suitable for LTE applications, the method and apparatus disclosed herein are not limited thereto. In one embodiment,

In one embodiment, there is provided a paging optimization system in a communications network, the communications network having base station nodes and wireless device nodes, the base station nodes providing access to the communications network for the wireless device nodes, the paging optimization system including a paging optimization node, the paging optimization node including, a tangible computer accessible medium having a Data Structure with at least one entry mapping at least one identifier representing a candidate wireless device node to at least one identifier representing a candidate paging base station node whereat the candidate wireless device node has some likelihood of being successfully paged by the candidate base station; a communications interface for communicating with other nodes in the communications network, communications including at least one paging related communication related to paging the candidate wireless device; and a processor configured to operate with the computer accessible memory and the communications interface, the processor adapted so as to attempt to optimize the at least one related paging communication by using the Data Structure. The processor may be further adapted to perform at least one of the acts of maintaining the at least one entry and searching the at least one entry. The paging optimization node may be an MME node. The paging optimization node may be an RRC Function node. The paging optimization system may further include WiFi nodes. The at least one candidate wireless device node may include a UE. The at least one candidate paging base station node may include an eNB. The at least one related paging communication may include at least one of: GTP-C DL data notification, GTP-C DL data notification ack, S1AP Paging Request, RRC Paging, RRC Connection Setup, EMM Service Request, UE Initial Context Setup, S1AP Paging Response, Authentication, Radius Access Request, Radius Access Accept, Create Session Request, Create Session Response, Coverage Indication, Initial UE Message, Authentication Data, NAS Authentication Request, NAS Authentication Response, NAS Security Node Command, NAS Security Node Command Complete, Update Location, Cancel Location, Cancel Location Ack, Update Location Ack, Create Default Bearer Request, PCRF Interaction, Create Default Bearer Response, Initial Context Setup Request, Security Mode Command, First DL-Data, Security Mode Complete, UE Capability Enquiry, UE Capability Info, RRC Connection Reconfiguration, RRC Connection Reconfiguration Complete, Initial Context Setup Response, UL Information Transfer, First UL-Data, Update Bearer Request/Response, and Notify Request/Response. The at least one related paging communication may include at least one of the following information: UE Category, UE identifier, eNB identifier, EAP ID, IMSI, M-TMSI, IP address, and ECGI. The at least one entry may include at least one of the following identifiers: eNB-identifier, TA-Identifier, Cell-Identifier, ECGI, UE-Category, IMSI, M-TMSI, IP address, UE-Identifier, time-of-day, day-of-the-week, Criteria, day-of-the-week, and time-of-day.

In another embodiment, there is provided a paging optimization method in a communications network, the communications network having base station nodes and wireless device nodes, the base station nodes providing access to the communications network for the wireless device nodes, the paging optimization method operating in a paging optimization node, the method comprising the steps of: maintaining at least one entry in a Data Structure for mapping at least one wireless device node to at least one base station node; searching for an at least one base station node to page the at least one wireless device node; and communicating at least one paging related communication related to paging the at least one wireless device by using the Data Structure thereby attempting to optimize paging the at least one wireless device node. The paging optimization node may be an MME node. The paging optimization node may be an RRC Function node. The communication network may further include at least one WiFi node. The paging optimization method may further include the step of determining one of a paging response time out and a paging failure received. The paging optimization method may further include the step of sending paging requests to all remaining base stations in a tracking area in response to the step of determining one of a paging response timeout and a paging failure received. The at least one entry may include at least one of the following identifiers: eNB-identifier, TA-Identifier, Cell-Identifier, ECGI, UE-Category, IMSI, M-TMSI, IP address, UE-Identifier, time-of-day, day-of-the-week, Criteria, day-of-the-week, and time-of-day. The at least one paging communication may include a page sent to a most likely base station. The paging optimization method in claim 11, wherein the maintaining step occurs when a wireless device node attaches to a wireless base station. The maintaining step may occur when a wireless device node does not respond to a page from a wireless base station.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram view of a network nodes involved in paging;

FIG. 2 is a signaling diagram view of a paging flow provided in accordance with the technique of the 3gpp solution;

FIG. 3 is a signaling diagram view of a paging flow provided in accordance with an embodiment of the paging technique of the present disclosure;

FIG. 4 is a block diagram view of a data structure provided in accordance with an embodiment of the paging technique of the present disclosure;

FIG. 5 is a block diagram view of a data structure provided in accordance with an embodiment of the paging technique of the present disclosure;

FIG. 6 is a signaling diagram view of a paging flow provided in accordance with an embodiment of the paging technique of the present disclosure;

FIG. 7 is a signaling diagram view of a paging flow provided in accordance with an embodiment of the paging technique of the present disclosure;

FIG. 8 is a signaling diagram view of a paging flow provided in accordance with an embodiment of the paging technique of the present disclosure;

FIG. 9 is a signaling diagram view of a paging flow provided in accordance with an embodiment of the paging technique of the present disclosure;

FIG. 10 is a signaling diagram view of a first portion of a paging flow provided in accordance with an embodiment of the paging technique of the present disclosure; and

FIG. 11 is a signaling diagram view of a second portion of a paging flow provided in accordance with an embodiment of the paging technique of the present disclosure.

FIG. 12 is a block diagram view of a paging optimization system provided in accordance with an embodiment of the paging technique of the present invention; and

FIG. 13 is a flow chart diagram view of a paging optimization method provided in accordance with an embodiment of the paging technique of the present invention.

For purposes of clarity and brevity, like elements and components will bear the same designations and numbering throughout the Figures.

### DETAILED DESCRIPTION

The 3GPP solution may not take into account static (non-mobile) devices which are predicted to become increasingly common. As well as being statically located, these static devices may be infrequent users of the network for data transmission and may therefore spend most of their time in an idle state which may require the network to initiate the paging process in order to push DL data. The 3GPP solution may not enable any optimizations for predicting the likely location of a UE 70 based on UE 70 behavior, location and mobility history. The 3GPP solution may not enable any optimizations for inferring the UE 70 location (and thus LTE eNB 20) based on the UEs attachment to a WiFi network such as for example in a venue node type deployment.

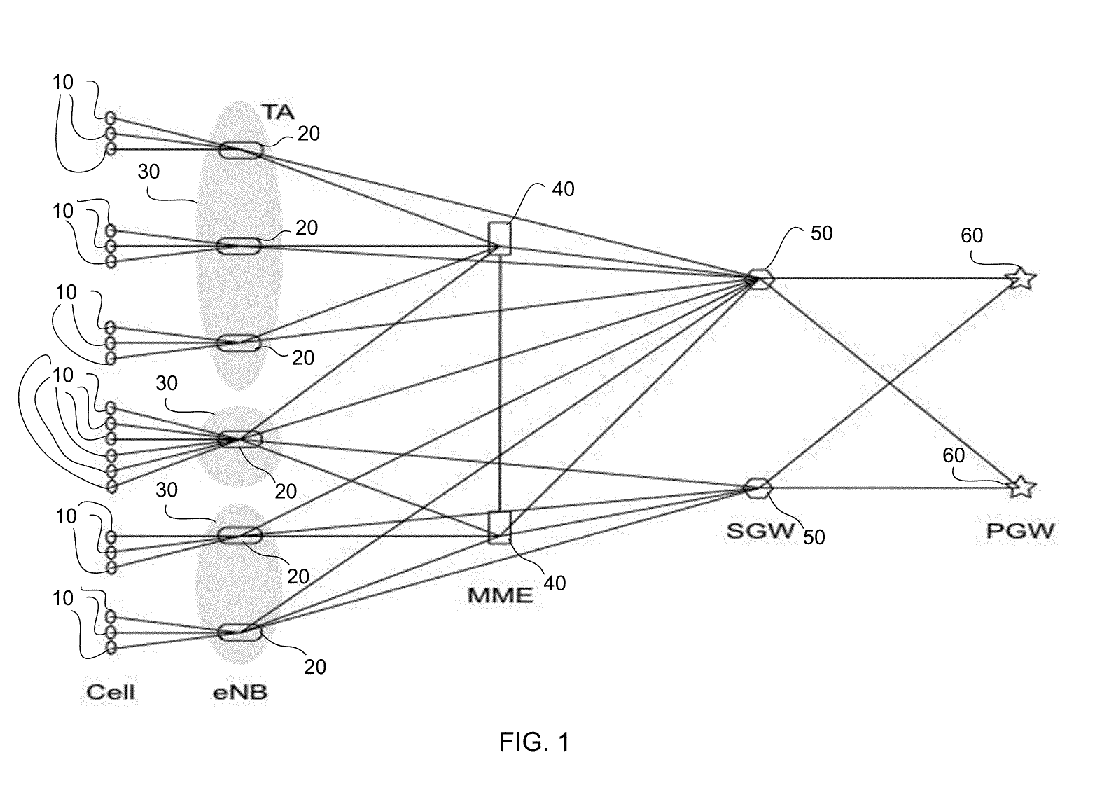

FIG. 1 is a block diagram view of a network nodes involved in paging. Several instances of a Cell 10 are served by each eNB 20. Multiple eNB 20 are grouped into a TA 30 for the purposes of paging. Each of the eNB 20 is connected to an MME 40 and a SGW 50, which are also connected to each other. Each SGW 50 is connected to one or more PGW 60. When internet traffic destined to a wireless device arrives at a PGW 60, the traffic is ultimately routed via an SGW 50 and an MME 40 to an eNB 20 that sends the internet traffic to the Cell 10 of the wireless device. The eNB 20 where traffic is routed is determined by the MME 40 by paging the wireless device at each of the eNB 20 of the last TA 30 known to be associated with the wireless device.

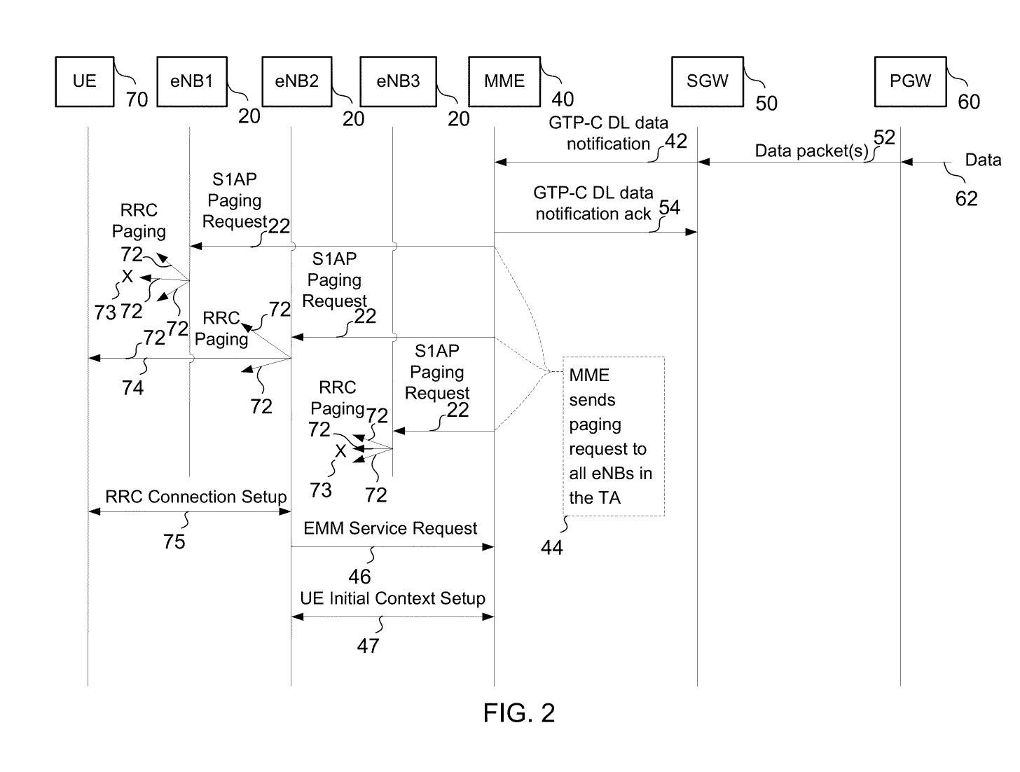

FIG. 2 is a signaling diagram view of a paging flow provided in accordance with the technique of the 3GPP solution. PGW 60 receives DL-Data 62 that is packetized into Data-Packets 52 sent to SGW 50. SGW 50 sends a GTP-C-DL-Data-Notification 42 to MME 40, and in response MME 40 sends a GTP-C-DL-Data-Notification-Ack 54 back to the SGW 50. The TA 30 in this example includes three eNB 20: eNB1, eNB2 and eNB3. Accordingly, an S1AP-Paging-Request 22 is sent to each eNB 20 (eNB1, eNB2 and eNB3) by MME 40 at Send-To-All-eNBs-In-TA 44. Each of eNB 20 eNB1, eNB2 and eNB3 send RRC-Paging 72 to page UE 70. eNB1 and eNB3 pages result in RRC-Paging-Failure 73 while eNB2 page results in RRC-Paging-Success 74. UE 70 and eNB 20 eNB2 proceed to RRC-Connection-Setup 75, and eNB2 sends EMM-Service-Request 46 to MME 40, and UE-Initial-Context-Setup 47 is realized between eNB 20 eNB2 and MME 40.

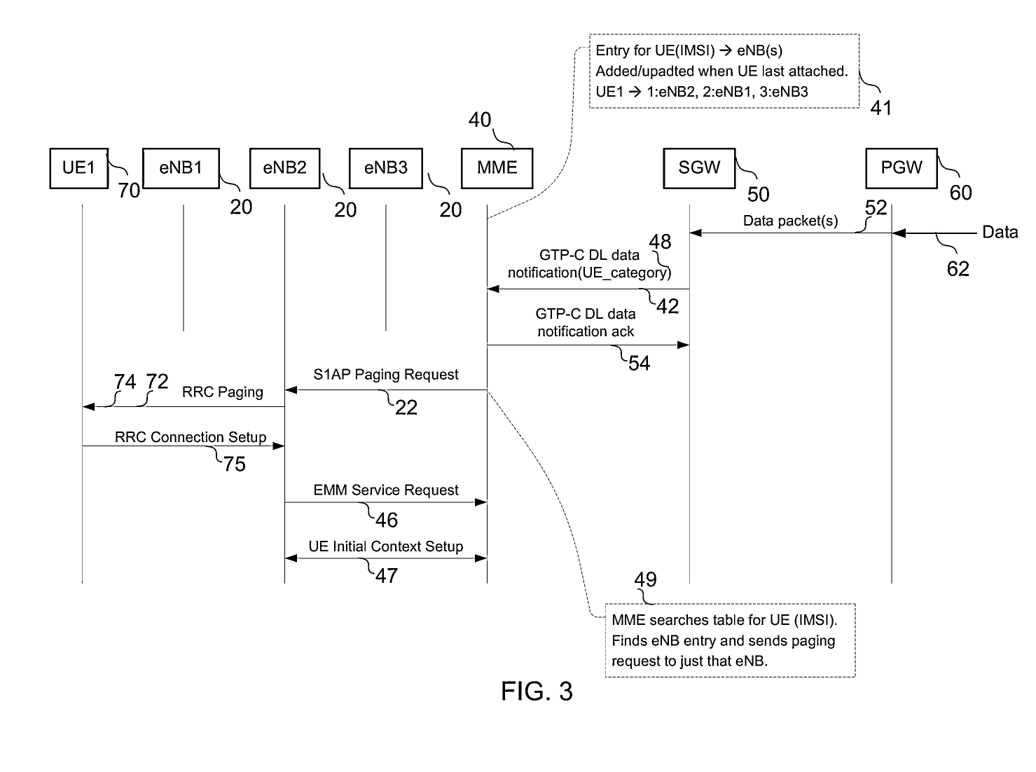

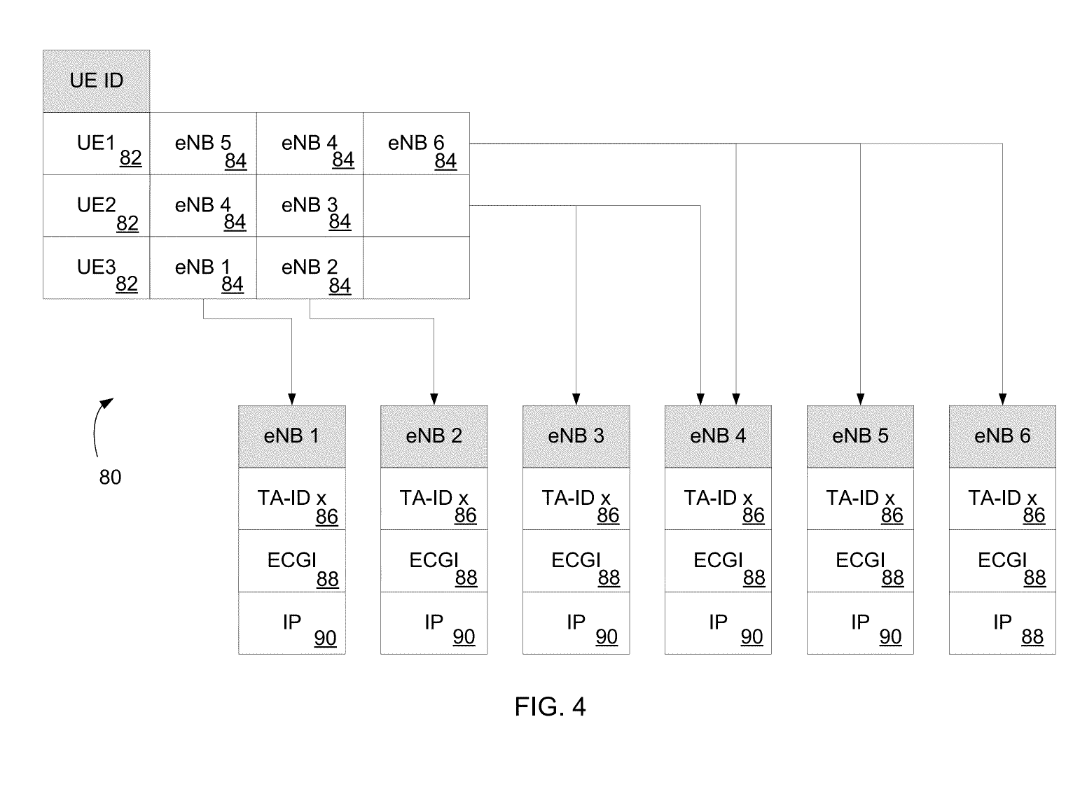

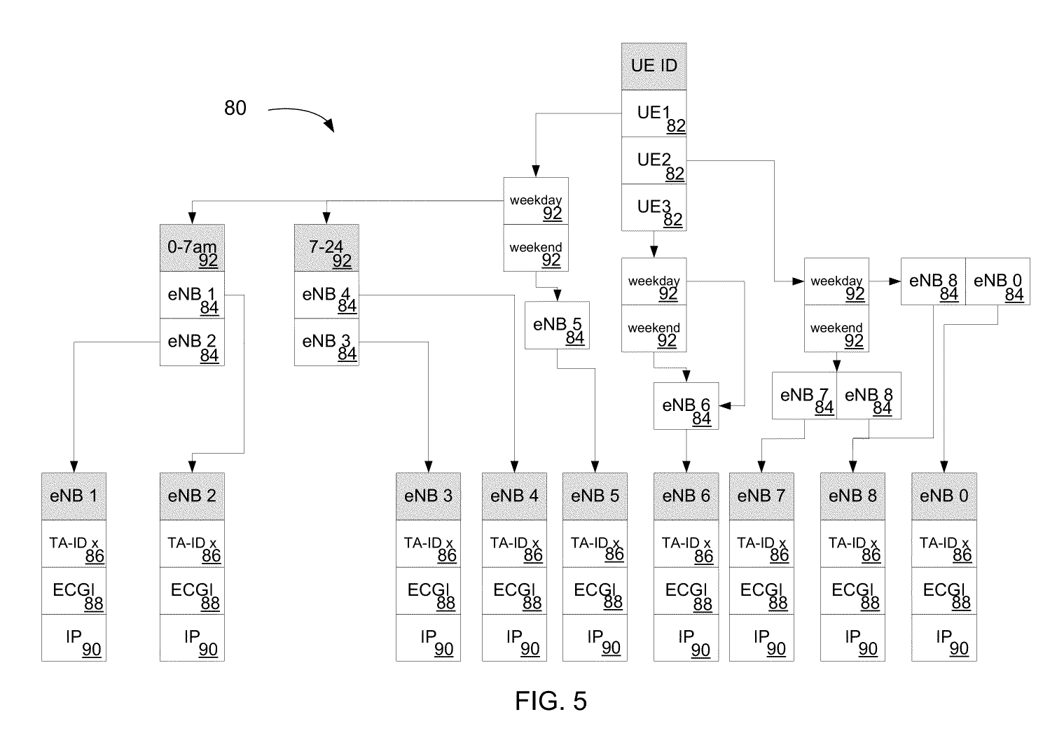

FIG. 3 is a signaling diagram view of a paging flow provided in accordance with an embodiment of the paging technique of the present invention. PGW 60 receives DL-Data 62 that is packetized into Data-Packets 52 sent to SGW 50. SGW 50 sends a GTP-C-DL-Data-Notification 42 to MME 40 optionally including a UE-Category 48, and in response MME 40 sends a GTP-C-DL-Data-Notification-Ack 54 back to the SGW 50. Although the TA 30 in this example includes three eNB 20: eNB1, eNB2 and eNB3; advantageously an S1AP-Paging-Request 22 is only sent to eNB 20 eNB2 by MME 40 at UE-entry-Found 49. This is because at UE-entry-Found 49 an entry for the UE 70 was found that enabled the MME 40 to select eNB 20 eNB2. The entry for UE 70 was maintained at UE-entry-Maintained 41, whereat MME 40 has maintained a Data-Structure 80 (see FIGS. 4 and 5) which in this example is implemented as a table, including an entry for UE 70 that has been added/updated when UE 70 last attached. The entry listed eNB 20 eNB2 as the most likely to succeed in sending an RRC-Paging 72 to page UE 70 thereby advantageously resulting in RRC-Paging-Success 74. Further advantageously, MME 40 did not have to send S1AP-Paging-Request 22 to eNB 20 eNB1 and eNB 20 eNB3, thereby saving resources. Yet further advantageously, eNB 20 eNB1 and eNB 20 eNB2 did not have to send RRC-Paging 72 that would have resulted in RRC-Paging-Failure 73, thereby further saving resources. As with the example in FIG. 2, UE 70 and eNB 20 eNB2 proceed to RRC-Connection-Setup 75, and eNB2 sends EMM-Service-Request 46 to MME 40, and UE-Initial-Context-Setup 47 is realized between eNB 20 eNB2 and MME 40, with the advantage compared to FIG. 2 that fewer resources were used to achieve this.

FIG. 4 is a block diagram view of a data structure provided in accordance with an embodiment of the paging technique of the present invention. MME 40 maintains one or more Data-Structure 80 at least mapping UE 70 (identified for example by IMSI 109 and/or M-TMSI and/or IP address) to eNB 20 (identified for example by Evolved Cell 10 Global Identifier and/or eNB-node ID and/or IP address) includes three example entries, one for each UE-Identifier 82, each representing an individual UE 70: UE1, UE2 and UE3. Each entry further maps each of the three UE-Identifier 82 with on or more of 6 example eNB-Identifier 84, each representing an individual eNB 20: eNB1, eNB2, eNB3, eNB4, eNB5, eNB6. Data-Structure 80 further includes some additional information, such as for each eNB-Identifier 84 eNB1-eNB6, a TA-Identifier 86, Cell-Identifier 88 ECGI and IP-Address 90.

In some embodiments, it is envisaged that each Data-Structure 80 may be specified for different UE-Category 48 (to be explained in further detail below). Furthermore, in some embodiments, the Data-Structure 80 may group the eNB-Identifier by TA-Identifier 86. In some embodiments, entries for each UE 70 may contain 1 or more TA-Identifier 86 groups. In some embodiments, Data-Structure 80 can be specific to a certain UE-Category 48, e.g. through operator defined policies, a UE-Identifier 82 will only be added to a Data-Structure 80 if it belongs to a specific one of the UE-Category 48. For example, the operator may only want to allow UE-Identifier 82 that are categorized as “non-mobile” type devices in order to speed up table searches and reduce the system memory required to store the Data-Structure 80. In some embodiments, Entries can map UE-Identifier 82 to 1 or more Cell-Identifier 88 ECGI or eNB-Identifier 84. In some embodiments, entries representative of each eNB 20 for each UE-Identifier 82 may be ordered based on recent UE 70 attachment, e.g. most successfully used or last used.

In some embodiments, it is envisaged that Data-Structure 80 can blacklist eNB 20 by Cell-Identifier 88 ECGI or eNB-Identifier 84 under operator configurable policies. For example if a UE 70 performs a tracking area update to an eNB 20 cell 10 with a very small coverage in a high mobility location (such as in a subway station for example), there is a high chance that the UE 70 will move quickly into the coverage of a different eNB 20 Cell 10, in which case, paging just that eNB 20 Cell 10 will have a higher chance of failure. When an Cell-Identifier 88 ECGI or eNB-Identifier 84 entry is not permitted in the Data-Structure 80, advantageously, the existing 3GPP solution is used unless the UE 70 entry included at least one other Cell-Identifier 88 ECGI or eNB-Identifier 84 entry.

In some embodiments, it is envisaged that entries in the Data-Structure 80 may be added or updated by triggers from the MME 40 itself (e.g. based upon UE-Category 48 or history of attaches), or the RRM function of eNB 20 or the like such as a venue node. In some embodiments, it is envisaged that entries in the Data-Structure 80 may be updated or removed by triggers from the MME 40 itself (e.g. based on paging success or failure, or time limited or number of records/memory limits).

FIG. 5 is a block diagram view of a data structure provided in accordance with an embodiment of the paging technique of the present invention. MME 40 maintains one or more Data-Structure 80 at least mapping UE 70 (identified for example by IMSI 109 and/or M-TMSI and/or IP address) to eNB 20 (identified for example by Evolved Cell 10 Global Identifier and/or eNB-node ID and/or IP address) includes three example entries, one for each UE-Identifier 82 UE-ID, each representing an individual UE 70: UE1, UE2 and UE3. Each entry further maps each of the three UE-Identifier 82 with on or more of 6 example eNB-Identifier 84, each representing an individual eNB 20: eNB1, eNB2, eNB3, eNB4, eNB5, eNB6. In some embodiments, Data-Structure 80 is implemented as a table. In some embodiments, Data-Structure 80 further includes some additional information, such as for each eNB-Identifier 84 eNB1-eNB6, a TA-Identifier 86, Cell-Identifier 88 ECGI and IP-Address 90. Entries representative of each eNB 20 for each UE-Identifier 82 are further grouped based on time-of-day and/or day-of-the-week, and more generally according to various Criteria 92, each of which can be one of UE 70 specific, UE-Category 48 specific or common for all UE 70 regardless of UE-Category 48. In the example Data-Structure 80 illustrated, UE 70 having UE-Identifier 82 UE1 for example, uses day-of-the-week Criteria 92 differentiating weekend and weekday day-of-the-week, and then for the weekday further includes time-of-day Criteria 92 of 0-7 AM and 7-11 for mapping to at least one specific eNB-Identifier 84 corresponding to specific eNB 20. Advantageously, Data-Structure 80 therefore enables eNB 20 to prioritize sending S1AP-Paging-Request 22 to the most likely eNB 20 of eNB1, eNB2, eNB3, eNB4 and eNB5 depending on the day-of-the-week and time-of-day further reducing the use of resources required to achieve RRC-Paging-Success 74 for UE 70 UE1. For example, eNB-Identifier 84 eNB5 may correspond to the eNB 20 that is serving the Cell 10 at a cottage where UE 70 UE1 is on a given weekend, while eNB-Identifier 84 eNB1 and eNB2 may correspond to the eNB 20 that is serving the Cell 10 at the homes where UE 70 UE1 is on a given weekday evening, while eNB-Identifier 84 eNB3 and eNB4 may correspond to the eNB 20 that is serving the Cell 10 at the workplace where UE 70 UE1 is on a given weekday.

The specific Criteria 92 illustrated in FIG. 5 is meant to be exemplary only, and other Criteria 92 that would be obvious to a person of ordinary skill in the art in view of the present specification are envisaged by the inventor and therefore considered to be within the scope of embodiments of the present invention which are not limited to the examples in this present specification. More generally, Criteria 92 is envisaged to include any information stored in Data-Structure 80 that can be used in the mapping of UE-Identifier 82 to one or more eNB-Identifier 84 enabling an attempt to page UE 70 using reduced resources relative to the resources required by the 3GPP solution. Criteria 92 may be used to either group or differentiate one or more eNB-Identifier 84 mapped to a UE-Identifier 82. Criteria 92 can be used with other information outside Data-Structure 80, such as in the example, the instant time-of-day and/or the day-of-the-week where an attempt to page UE 70 is to be made.

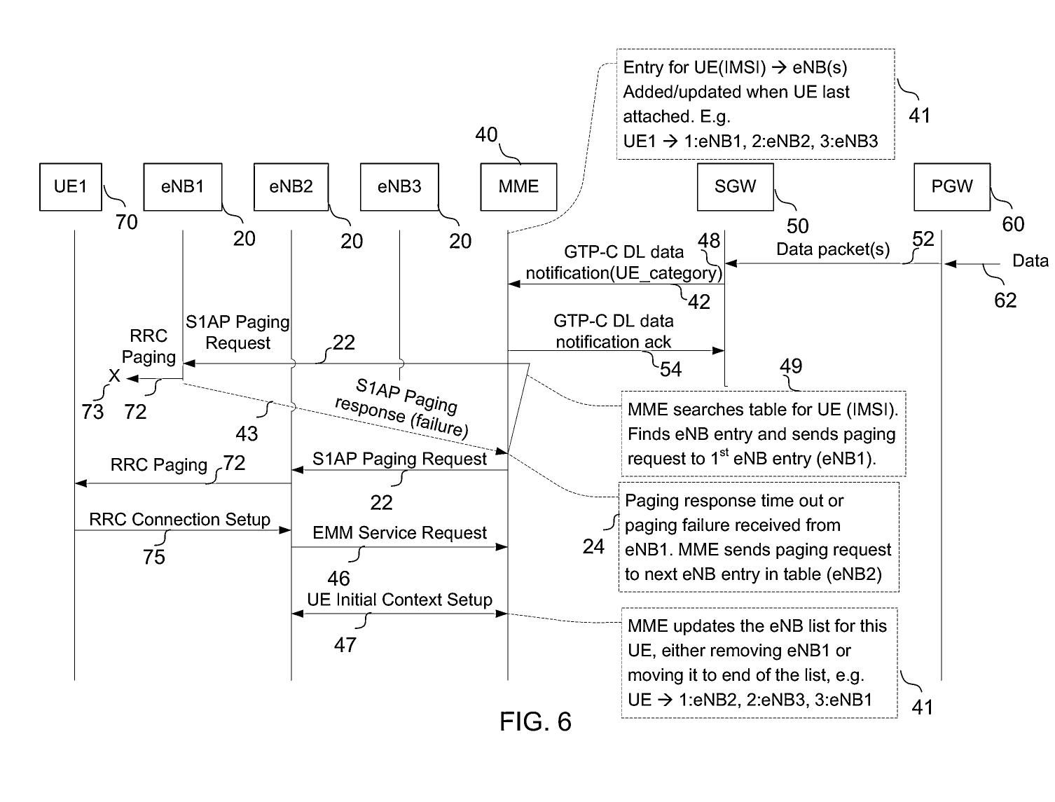

FIG. 6 is a signaling diagram view of a paging flow provided in accordance with an embodiment of the paging technique of the present invention. PGW 60 receives DL-Data 62 that is packetized into Data-Packets 52 sent to SGW 50. SGW 50 sends a GTP-C-DL-Data-Notification 42 to MME 40 optionally including a UE-Category 48, and in response MME 40 sends a GTP-C-DL-Data-Notification-Ack 54 back to the SGW 50. Although the TA 30 in this example includes three eNB 20: eNB1, eNB2 and eNB3; advantageously an S1AP-Paging-Request 22 is first sent to eNB 20 eNB1 by MME 40 at UE-entry-Found 49 in an attempt to page UE 70 using reduced resources relative to the resources required by the 3GPP solution. This is because prior to this, at UE-entry-Maintained 41, MME 40 has maintained a UE-Category 48 specific Data-Structure 80 which in this example is implemented as a table, for the UE-Category 48 of the UE 70 having UE-Identifier 82 UE1 including an entry for UE 70 UE1 that has been added/updated when UE 70 UE1 last attached. Although the entry listed eNB 20 eNB1 as the most likely to succeed in an attempt at an RRC-Paging 72 to page UE 70, the result of the RRC-Paging 72 sent by eNB1 is in this example is RRC-Paging-Failure 73. Advantageously, S1AP-Paging-Response 43 is sent from eNB 20 eNB1 to MME 40 to indicate the failure whereat MME 40 recovers via the S1AP-Paging-Failure 24. At S1AP-Paging-Failure 24, in response to a paging response time out or paging failure received from eNB 20 eNB1, MME 40 advantageously makes a second attempt to save resources and sends paging request to the next eNB 20 entry in the table Data-Structure 80 that is now the most likely to achieve success, which in this case is eNB2. eNB2 page results in RRC-Paging-Success 74. MME 40 did not have to send S1AP-Paging-Request 22 to eNB 20 eNB3, thereby saving resources. Yet further advantageously, eNB3 did not have to send RRC-Paging 72 that would have resulted in RRC-Paging-Failure 73, thereby further saving resources. As with the example in FIGS. 2 and 3, UE 70 and eNB 20 eNB2 proceed to RRC-Connection-Setup 75, and eNB2 sends EMM-Service-Request 46 to MME 40, and UE-Initial-Context-Setup 47 is realized between eNB 20 eNB2 and MME 40, with the advantage compared to FIG. 2 that fewer resources were used to achieve this, and the advantage compared to FIG. 3 that MME 40 recovered quickly from a failed paging attempt. Further advantageously, at a second UE-entry-Maintained 41, the fact that the eNB-Identifier 84 that is most likely to achieve success is eNB2 is captured by updating the Data-Structure 80 table at MME 40.

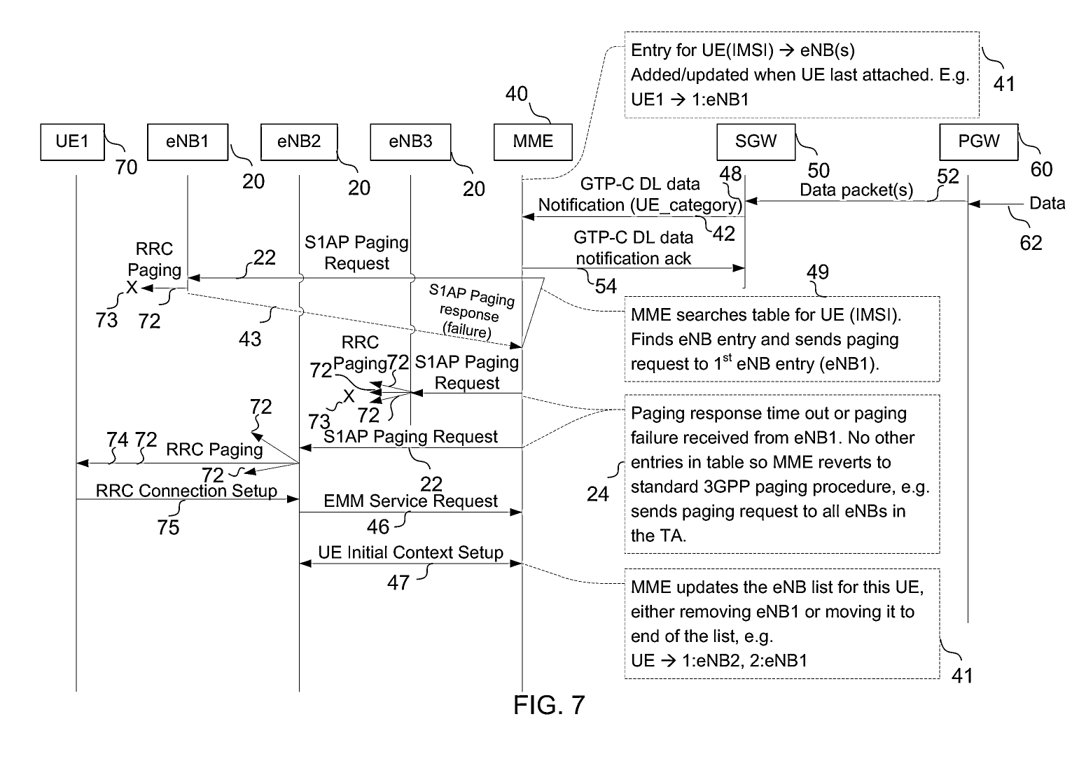

FIG. 7 is a signaling diagram view of a paging flow provided in accordance with an embodiment of the paging technique of the present invention. PGW 60 receives DL-Data 62 that is packetized into Data-Packets 52 sent to SGW 50. SGW 50 sends a GTP-C-DL-Data-Notification 42 to MME 40 optionally including a UE-Category 48, and in response MME 40 sends a GTP-C-DL-Data-Notification-Ack 54 back to the SGW 50. Although the TA 30 in this example includes three eNB 20: eNB1, eNB2 and eNB3; advantageously an S1AP-Paging-Request 22 is first sent to eNB 20 eNB1 by MME 40 at UE-entry-Found 49 in an attempt to page UE 70 using reduced resources relative to the resources required by the 3GPP solution. This is because prior to this, at UE-entry-Maintained 41, MME 40 has maintained a UE-Category 48 specific Data-Structure 80 which in this example is implemented as a table, for the UE-Category 48 of the UE 70 having UE-Identifier 82 UE1 including an entry for UE 70 UE1 that has been added/updated when UE 70 IUE1 last attached. Although the entry listed eNB 20 eNB1 as the most likely to succeed in an attempt at an RRC-Paging 72 to page UE 70, the result of the RRC-Paging 72 sent by eNB1 is in this example is RRC-Paging-Failure 73. Advantageously, S1AP-Paging-Response 43 is sent from eNB 20 eNB1 to MME 40 to indicate the failure whereat MME 40 recovers via the S1AP-Paging-Failure 24. At S1AP-Paging-Failure 24, in response to a paging response time out or paging failure received from eNB 20 eNB1, MME 40 advantageously reverts to standard 3GPP solution, e.g. it sends S1AP-Paging-Request 22 to all the remaining eNB 20: eNB2 and eNB3 in the TA 30 (as an alternative all eNB 20 in the TA 30 could be sent the paging request including eNB1). eNB3 sends RRC-Paging 72 that results in RRC-Paging-Failure 73 while eNB2 sends RRC-Paging 72 that results in RRC-Paging-Success 74. As with the example in FIGS. 2, 3 and 6, UE 70 and eNB 20 eNB2 proceed to RRC-Connection-Setup 75, and eNB2 sends EMM-Service-Request 46 to MME 40, and UE-Initial-Context-Setup 47 is realized between eNB 20 eNB2 and MME 40. Advantageously, MME 40 was able to revert to the 3GPPP solution in a timely or “fast track” manner. Further advantageously compared to FIG. 2, at a second UE-entry-Maintained 41, the fact that the eNB-Identifier 84 that is most likely to achieve success is now eNB2 is captured by updating the Data-Structure 80 table at MME 40, thereby increasing the likelyhood that further attempts to page UE 70 UE1 may reduce the number of resources used relative to the 3GPP solution of FIG. 2.

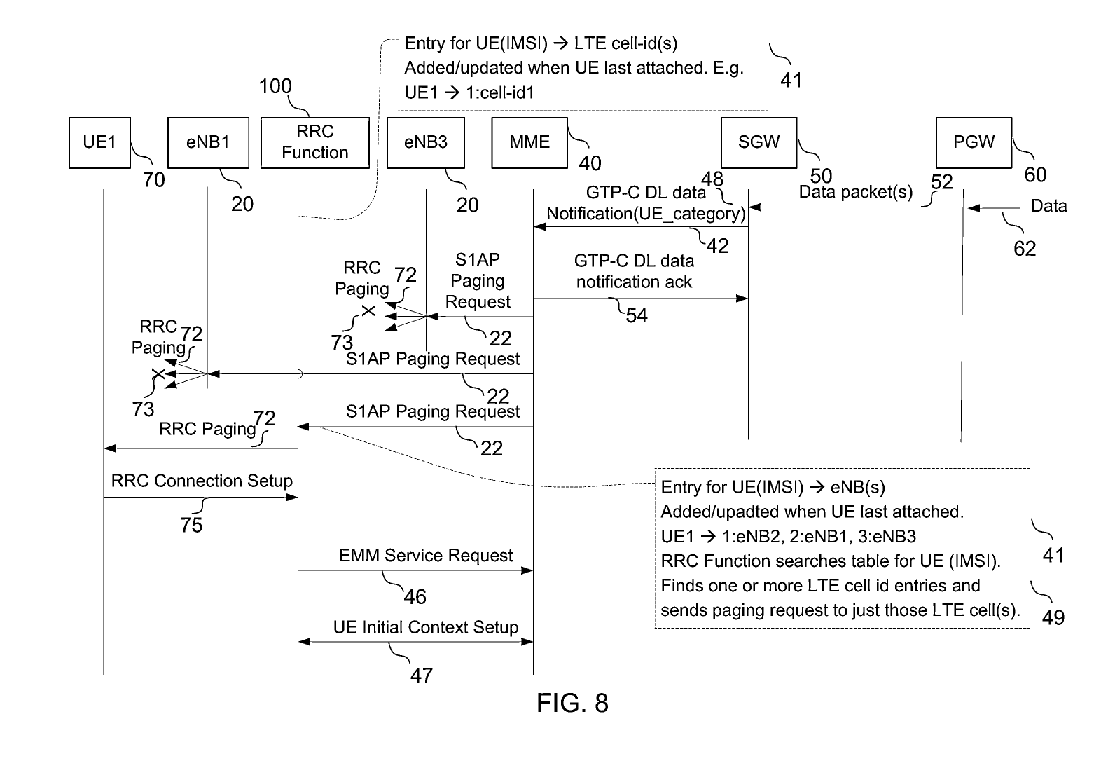

FIG. 8 is a signaling diagram view of a paging flow provided in accordance with an embodiment of the paging technique of the present invention. PGW 60 receives DL-Data 62 that is packetized into Data-Packets 52 sent to SGW 50. SGW 50 sends a GTP-C-DL-Data-Notification 42 to MME 40 optionally including a UE-Category 48, and in response MME 40 sends a GTP-C-DL-Data-Notification-Ack 54 back to the SGW 50. The TA 30 in this example includes three eNB 20: eNB1, eNB2 and eNB3. An S1AP-Paging-Request 22 is sent to eNB 20 eNB1 and eNB3 by MME 40 in accordance with the 3GPPP solution and instead of sending an S1AP-Paging-Request 22 to eNB2, advantageously, an S1AP-Paging-Request 22 is sent to an RRC-Function 100 for eNB2. Further details of the RRC-Function 100 are described in U.S. application Ser. No. 13/707,184 filed 6 Dec. 2012 entitled “Common Radio Resource Control for Cellular Radio and WiFi”, incorporated herein by reference in its entirety. Each of eNB 20 eNB1, eNB3 send RRC-Paging 72 to page UE 70 that results in RRC-Paging-Failure 73. At the RRC-Function 100, at a first UE-entry-Maintained 41 prior to the RRC-Function 100 receiving the S1AP-Paging-Request 22 from MME 40, a Data-Structure 80 was added/updated when UE 70 UE1 last attached, which in this example included an entry mapping UE-Identifier 82 UE1 to Cell-Identifier 88 cell-id-1. Upon receipt of the S1AP-Paging-Request 22 from MME 40, RRC-Function 100 at a second UE-entry-Maintained 41, the Data-Structure 80 is added/updated, and at UE-entry-Found 49, the RRC-Function 100 searches for the UE-Identifier 82 in the Data-Structure 80 (which in this instance is a table) to find one or more LTE Cell-Identifier 88 entries and sends paging request to just each of those LTE Cell 10 such that RRC-Function 100 RRC-Paging 72 results in RRC-Paging-Success 74. UE 70 and RRC-Function 100 proceed to RRC-Connection-Setup 75, and RRC-Function 100 sends EMM-Service-Request 46 to MME 40, and UE-Initial-Context-Setup 47 is realized between RRC-Function 100 and MME 40. Advantageously, MME 40 was able to use the 3GPPP solution while RRC-Function 100 enabled the use of Data-Structure 80 to optimize paging in a combined LTE and WiFi environment thereby increasing the likelihood that further attempts to page UE 70 UE1 may reduce the number of resources used relative to the 3GPP solution of FIG. 2.

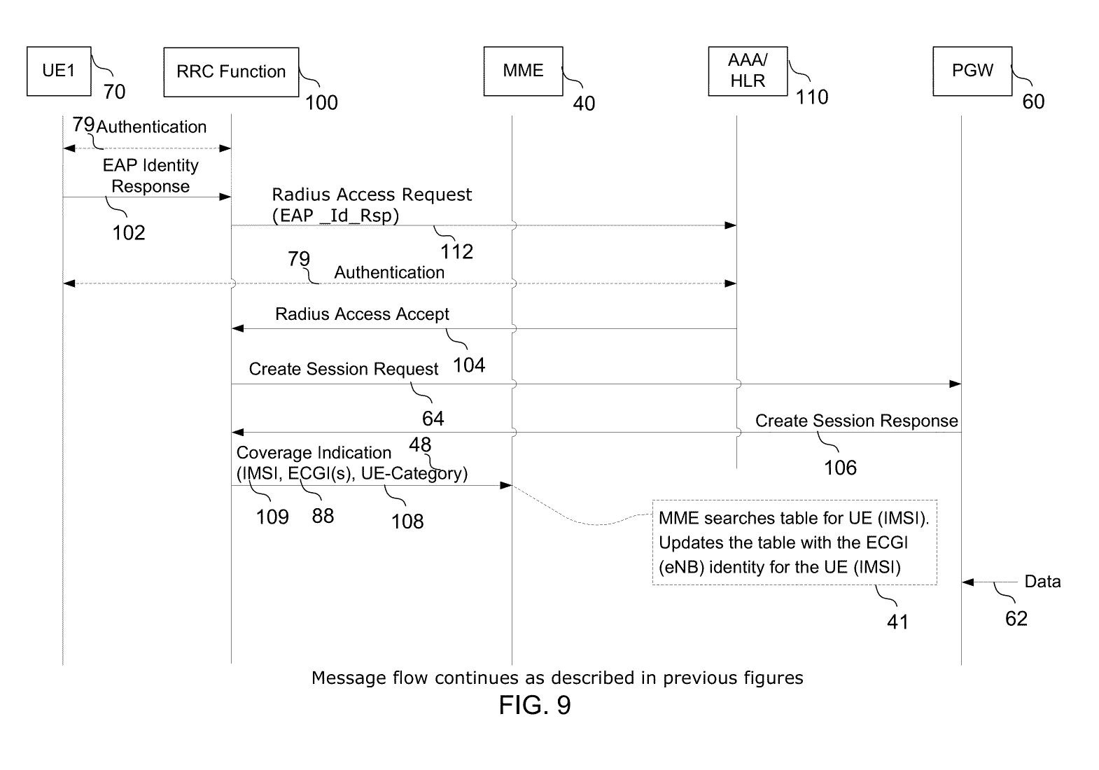

FIG. 9 is a signaling diagram view of a paging flow provided in accordance with an embodiment of the paging technique of the present invention. An S2a WiFi attach procedure proceeds as follows. UE 70 UE1 and RRC-Function 100 perform Authentication 79. UE 70 UE1 sends an EAP-Identity-Response 102 to RRC-Function 100. RRC-Function 100 then sends a Radius-Access-Request 112 to AAA/HLR 110. AAA/HLR 110 and UE 70 UE1 perform Authentication 79. AAA/HLR 110 sends Radius-Access-Accept 104 to RRC-Function 100. RRC-Function 100 sends Create-Session-Request 64 to PGW 60. PGW 60 sends Create-Session-Response 106 to RRC-Function 100. RRC-Function 100 sends Coverage-Indication 108 to MME 40 including for example IMSI 109, Cell-Identifier 88 ECGI, UE-Category 48. The MME 40 searches tables for UE 70 e.g. based on IMSI 109 and updates the table with e.g. Cell-Identifier 88 ECGI eNB 20 identity for the UE 70 at a UE-entry-Maintained 41. When DL-Data 62 arrives at PGW 60, message flow continues as described in previous figures.

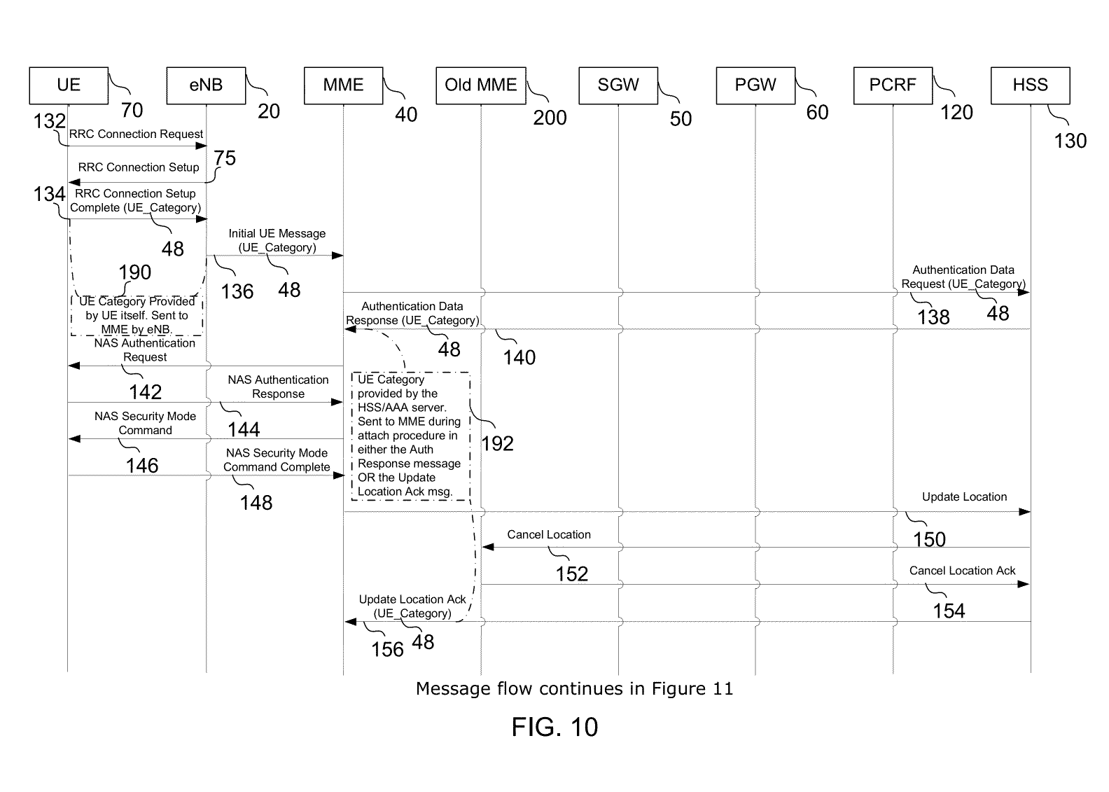

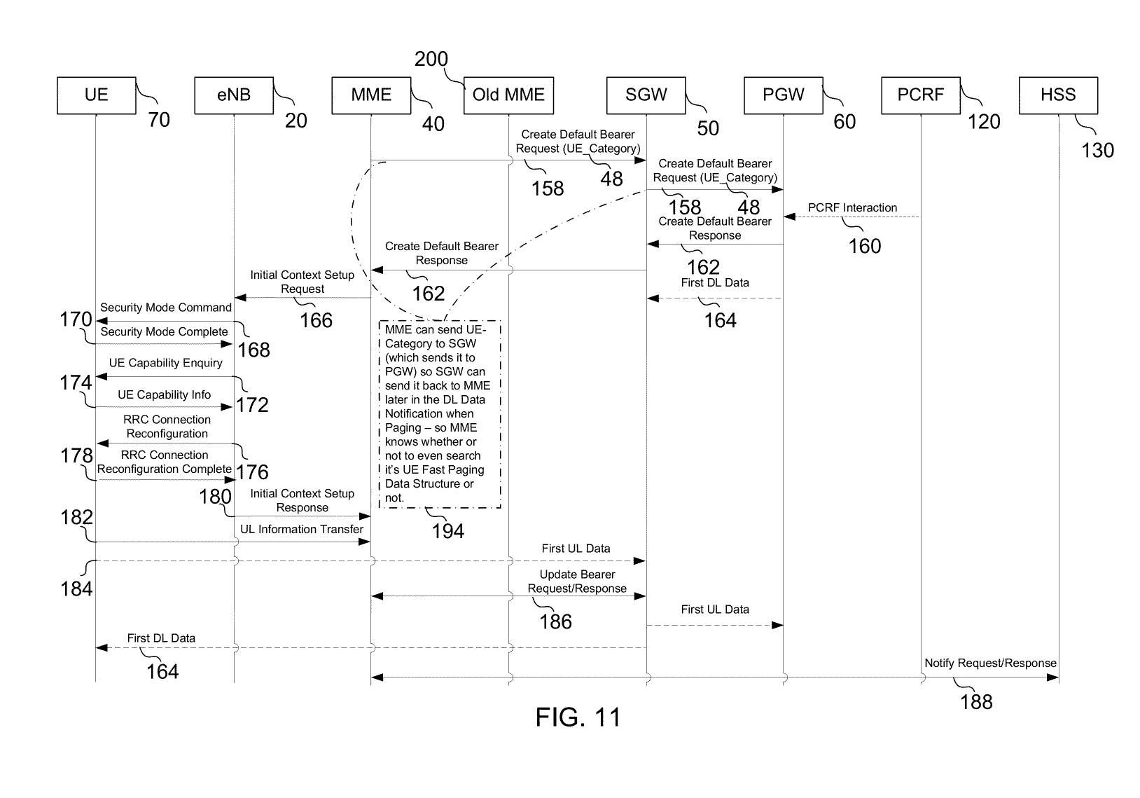

FIGS. 10 and 11 are a signaling diagram view of the first and second portion respectively of a paging flow provided in accordance with an embodiment of the paging technique of the present invention.

Beginning at FIG. 10, UE 70 sends RRC-Connection-Request 132 to eNB 20. eNB 20 sends RRC-Connection-Setup 75 to UE 70. UE 70 replies with RRC-Connection-Setup-Complete 134 optionally including UE-Category 48 as per UE-Provided-UE-Category 190 whereat UE-Category 48 is provided by the UE 70 itself and is sent to MME 40 by eNB 20. eNB 20 sends Initial-UE-Message 136 to MME 40 optionally including UE-Category 48. MME 40 sends Authentication-Data-Request 138 to HSS 130 optionally including UE-Category 48. HSS 130 replies to MME 40 with Authentication-Data-Response 140 to MME 40 including optional UE-Category 48 as per HSS/AAA-Provided-UE-Category 192 whereat UE-Category 48 is provided by the HSS 130 (or AAA) server, sent to MME 40 during attach procedure in the Authentication-Response message (or the Update-Location-Ack 156 msg). MME 40 sends NAS-Authentication-Request 142 to UE 70. UE 70 response with NAS-Authentication-Response 144 to MME 40. MME 40 sends NAS-Security-Mode-Command 146 to UE 70. UE 70 sends NAS-Security-Mode-Command-Complete 148 to MME 40. MME 40 sends Update-Location 150 to HSS 130. HSS 130 sends Cancel-Location 152 to Old-MME 200. Old-MME 200 sends Cancel-Location-Ack 154 to HSS 130. HSS 130 sends Update-Location-Ack 156 to MME 40 optionally including UE 70_Category as per HSS/AAA-Provided-UE-Category 192 whereat UE-Category 48 is provided by the HSS 130 (or AAA) server, sent to MME 40 during attach procedure in the the Update-Location-Ack 156 msg (or the Authentication-Response message).

Continuing at FIG. 11, MME 40 sends Create-Default-Bearer-Request 158 to SGW 50 and SGW 50 sends the same to PGW 60, in both cases optionally including UE-Category 48 as per MME/SGW/PGW-Provided-UE-Category 194 whereat MME 40 can send UE-Category 48 to SGW 50 (which sends it to PGW 60) so SGW 50 can send it back to MME 40 later in the First-DL-Data 164 Notification when paging so MME 40 knows whether or not to even search it's UE 70 Fast Paging Data-Structure 80 or not. PCRF-Interaction 160 occurs between PCRF 120 and PGW 60. PGW 60 sends Create-Default-Bearer-Response 162 to SGW 50 and SGW 50 sends the same to MME 40. Initial-Context-Setup-Request 166 is sent from MME 40 to eNB 20. Meanwhile, First-DL-Data 164 is sent from PGW 60 to SGW 50 optionally including UE-Category 48. eNB 20 sends Security-Mode-Command 168 to UE 70 and UE 70 replies to eNB 20 with Security-Mode-Complete 170. eNB 20 sends UE-Capability-Enquiry 172 to UE 70 and UE 70 replies to eNB 20 with UE-Capability-Info 174. eNB 20 sends RRC-Connection-Reconfiguration 176 to UE 70 and UE 70 replies to NB with RRC-Connection-Reconfiguration-Complete 178. eNB 20 sends Initial-Context-Setup-Response 180 to MME 40. UE 70 sends UL-Information-Transfer 182 to MME 40. UE 70 sends First-UL-Data 184 to SGW 50. SGW 50 and MME 40 interact via Update-Bearer-Request/Response 186. SGW 50 sends First-UL-Data 184 to PGW 60. SGW 50 sends First-DL-Data 164 to UE 70. MME 40 and HSS 130 interact via Notify-Request/Response 188.

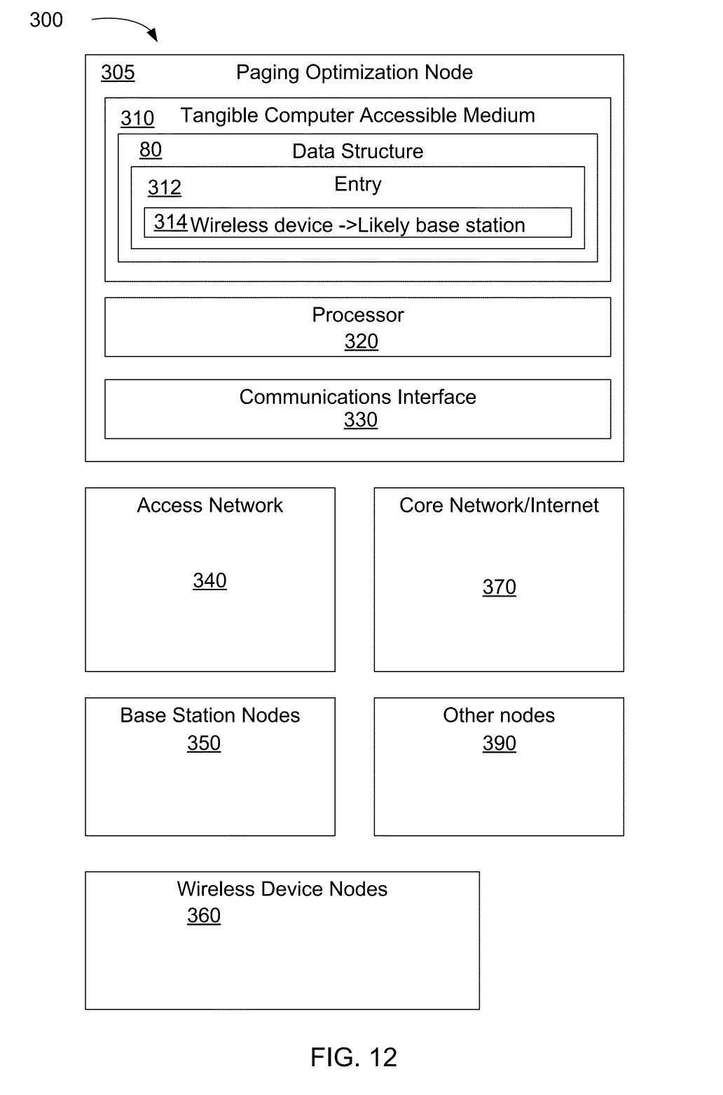

FIG. 12 is a block diagram view of a paging optimization system provided in accordance with an embodiment of the paging technique of the present invention. The paging optimization system 300 includes a paging optimization node 305, capable of communicating with base station nodes 350 and wireless device nodes 360 via an access network 340, and capable of communication with other nodes 390 via a core network/internet 370. Paging optimization node 305 includes a tangible computer accessible medium, processor 320 and communications interface 330. The tangible computer accessible medium 310 includes a data structure 80. The data structure 80 includes at least one entry 312 wherein is a mapped 314 at least one wireless device to at least one likely base station. In some embodiments, the paging optimization node 305 is the MME 40 and/or the RRC-Function 100, wireless device nodes 460 include UE 70, and base station nodes 350 include eNB 20 such that the techniques of the previous figures can operate on the system of FIG. 12.

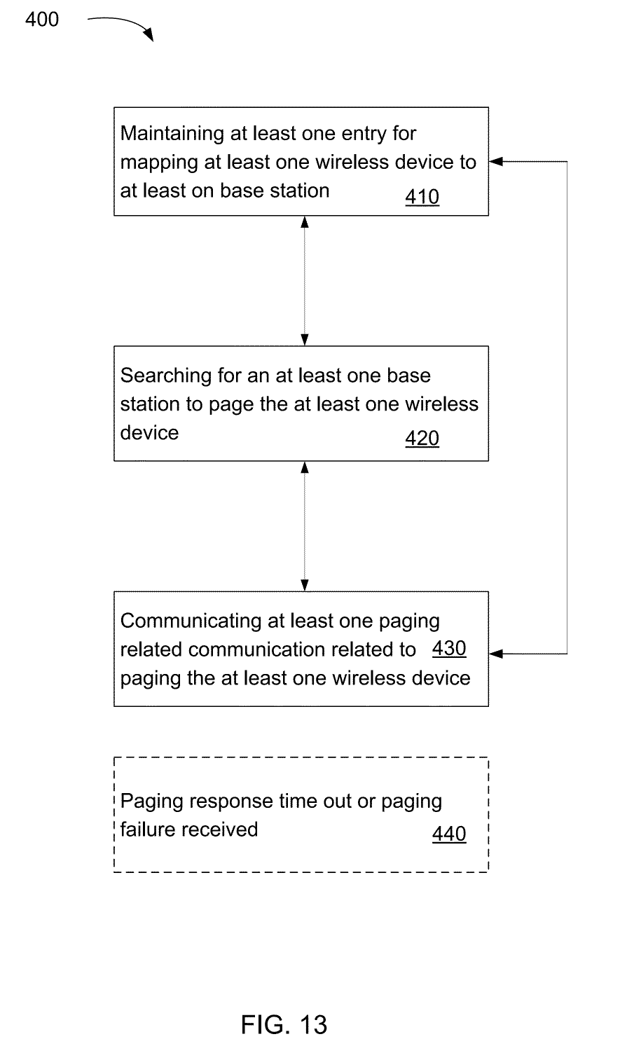

FIG. 13 is a flow chart diagram view of a paging optimization method provided in accordance with an embodiment of the paging technique of the present invention. The paging optimization method 400 includes a step 410 of maintaining at least one entry for relating at least one wireless device to at least one base station, a step 420 of searching for an at least one base station to page the at least one wireless device, and a step 430 of communicating at least one paging related communication related to paging the at least one wireless device. As indicated in the flow chart, in alternate embodiments the steps can flow from one another in different order. At optional step 440 paging response timeout or paging failure is received and can trigger other steps.

Those skilled in the art will recognize improvements and modifications to the preferred embodiments of the present disclosure. All such improvements and modifications are considered within the scope of the concepts disclosed herein and the claims that follow.

What is claimed is:

1. A paging optimization system in a communications network, the communications network having base station nodes and wireless device nodes, the base station nodes providing access to the communications network for the wireless device nodes, the paging optimization system comprising:
a paging optimization node, comprising:
a tangible computer accessible medium having a Data Structure with at least one entry mapping at least one identifier representing a candidate wireless device node to at least one identifier representing a candidate paging base station node whereat the candidate wireless device node has some likelihood of being successfully paged by the candidate base station;
a communications interface for communicating with other nodes in the communications network, communications including at least one paging related communication related to paging the candidate wireless device;
a processor configured to operate with the computer accessible memory and the communications interface, the processor adapted so as to attempt to optimize the at least one related paging communication by using the Data Structure.

2. The paging optimization system of claim 1 wherein the processor is further adapted to perform at least one of the acts of maintaining the at least one entry and searching the at least one entry.

3. The paging optimization system of claim 1 wherein the paging optimization node is an MME node.

4. The paging optimization system of claim 1 wherein the paging optimization node is an RRC Function node.

5. The paging optimization system of claim 1 further comprising WiFi nodes.

6. The paging optimization system of claim 1 wherein the at least one candidate wireless device node includes a UE.

7. The paging optimization system of claim 1 wherein the at least one candidate paging base station node includes an eNB.

8. The paging optimization system of claim 1 wherein the at least one related paging communication includes at least one of: GTP-C DL data notification, GTP-C DL data notification ack, S1AP Paging Request, RRC Paging, RRC Connection Setup, EMM Service Request, UE Initial Context Setup, S1AP Paging Response, Authentication, Radius Access Request, Radius Access Accept, Create Session Request, Create Session Response, Coverage Indication, Initial UE Message, Authentication Data, NAS Authentication Request, NAS Authentication Response, NAS Security Node Command, NAS Security Node Command Complete, Update Location, Cancel Location, Cancel Location Ack, Update Location Ack, Create Default Bearer Request, PCRF Interaction, Create Default Bearer Response, Initial Context Setup Request, Security Mode Command, First DL-Data, Security Mode Complete, UE Capability Enquiry, UE Capability Info, RRC Connection Reconfiguration, RRC Connection Reconfiguration Complete, Initial Context Setup Response, UL Information Transfer, First UL-Data, Update Bearer Request/Response, and Notify Request/Response.

9. The paging optimization system of claim 1 wherein the at least one related paging communication includes at least one of the following information: UE Category, UE identifier, eNB identifier, EAP ID, IMSI, M-TMSI, IP address, and ECGI.

10. The paging optimization system of claim 1 wherein the at least one entry includes at least one of the following identifiers: eNB-identifier, TA-Identifier, Cell-Identifier, ECGI, UE-Category, IMSI, M-TMSI, IP address, UE-Identifier, time-of-day, day-of-the-week, Criteria, day-of-the-week, and time-of-day.

11. A paging optimization method in a communications network, the communications network having base station nodes and wireless device nodes, the base station nodes providing access to the communications network for the wireless device nodes, the paging optimization method operating in paging optimization node, the method comprising the steps of:
maintaining at least one entry in a Data Structure for mapping at least one wireless device node to at least one base station node;
searching for an at least one base station node to page the at least one wireless device node; and
communicating at least one paging related communication related to paging the at least one wireless device by using the Data Structure thereby attempting to optimize paging the at least one wireless device node.

12. The paging optimization method of claim 11 wherein the paging optimization node is an MME node.

13. The paging optimization method of claim 11 wherein the paging optimization node is an RRC Function node.

14. The paging optimization method of claim 11 further comprising at least one WiFi node.

15. The paging optimization method of claim 11, further comprising the step of determining one of a paging response time out and a paging failure received.

16. The paging optimization method of claim 15, further comprising the step of sending paging requests to all remaining base stations in a tracking area in response to the step of determining one of a paging response timeout and a paging failure received.

17. The paging optimization method of claim 11, wherein the at least one entry includes at least one of the following identifiers: eNB-identifier, TA-Identifier, Cell-Identifier, ECGI, UE-Category, IMSI, M-TMSI, IP address, UE-Identifier, time-of-day, day-of-the-week, Criteria, day-of-the-week, and time-of-day.

18. The paging optimization method in claim 11, wherein the at least one paging communication comprises a page sent to a most likely base station.

19. The paging optimization method in claim 11, wherein the maintaining step occurs when a wireless device node attaches to a wireless base station.

20. The paging optimization method in claim 11, wherein the maintaining step occurs when a wireless device node does not respond to a page from a wireless base station.
